(19) United States
(12) Patent Application Publication
(10) Pub. No.: US 2018/0253899 A1
(43) Pub. Date: Sep. 6, 2018

(54) METHOD AND DEVICE FOR DISPLAYING OBJECTS ON A VEHICLE DISPLAY

(71) Applicant: Conti Temic Micorelectronic GMBH, Nuremburg (DE)

(72) Inventor: Jörg Schrepfer, Tettau (DE)

(21) Appl. No.: 15/128,784

(22) PCT Filed: Jan. 28, 2015
(86) PCT No.: PCT/DE2015/200036

§ 371 Date: May 17, 2018

(30) Foreign Application Priority Data
Mar. 25, 2014 (DE) 10 2014 205 511.3

(51) Int. Cl. G06T 19/00; G06K 9/00; G06K 9/62; G06T 7/70; G01C 21/36

(52) U.S. Cl. CPC G06T 19/006; G06K 9/00805; G06K 9/6267; H04L 67/12; G01C 21/3638; G01C 21/367; G06K 2209/23; G06T 7/70

(57) ABSTRACT

A method for displaying objects on a vehicle display of a vehicle (F) comprising the following steps: (a) providing (S1) sensed environment images (UB), that have objects (O) that are located in the environment of the vehicle (F); (b) classifying (S2) the objects (O) on the basis of object features in order to detect an object type (O-TYP) of the particular object (O); (c) inserting (S3) a three-dimensional data model (3D-DM) corresponding to the detected object type (O-TYP) of the object (O) in order to generate a 3-D scene that shows the environment of the vehicle (F); and (d) displaying (S4) the generated 3-D scene on the vehicle display.

The invention relates to a method and a device for displaying objects, in particular vehicle objects, on a vehicle display of a vehicle.

Vehicles are increasingly being fitted with surround view systems, which calculate a display image from camera images, thereby assisting the driver in performing driving maneuvers, such as parking and reversing. While driving, with the assistance of the surround view system, the driver is able to take decisions allowing safer control of the vehicle in road traffic. Furthermore, the surround view system can assist in driver orientation in the environment, thereby allowing them, for example, to reach their destination more easily. In order to provide this driver with the most realistic possible image of the environment of the vehicle, three-dimensional displays are also increasingly being used on the vehicle display, in order to provide the driver with the most efficient possible assistance in their decision-making and orientation.

A disadvantage of conventional surround view systems, however, is that the objects detected by vehicle sensors, in particular vehicle cameras, are recorded from the perspective of the vehicle sensor concerned and other sides of the object concerned are not identifiable or visible. Furthermore, in many cases, other vehicle objects are completely or partially obscured by other objects, in particular other vehicle objects, so that a realistic display of the obscured vehicle object is not possible.

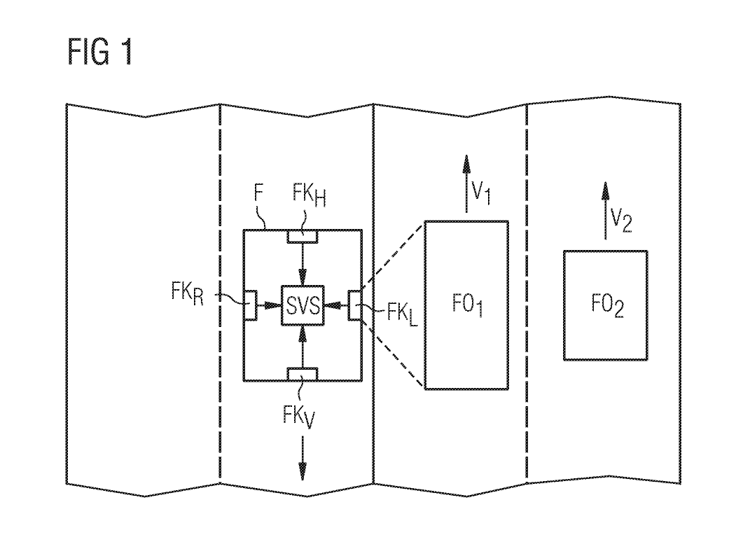

This problem is explained by way of example using FIG. 1. The example shown in FIG. 1 relates to a traffic situation in which a vehicle F and two further vehicle objects encounter one another on a four-lane highway. In the example shown the highway has four traffic lanes, each with two lanes in each direction. The highway shown in FIG. 1 is for example a freeway, with two lanes of traffic in each direction. In the example shown, the vehicle F has an SVS surround view system, receiving camera images from four vehicle cameras, positioned on the left and right sides and the front and back of the vehicle. In the oncoming traffic in the example shown, a first vehicle object FO1, for example an automobile or a truck, overtakes a second vehicle object FO2 and obscures this at least partially. The vehicle camera FK_{L} positioned on the left-hand side of the vehicle F therefore detects only the left-hand side of the first vehicle object FO1 and furthermore possibly subareas of the left-hand side of the obscured second vehicle object FO2. At a certain point in time the second vehicle object FO2 is completely obscured by the first vehicle object FO1 for the vehicle camera FK_{L}, making a realistic representation of the vehicle object FO2 in a three-dimensional scene on a vehicle display of the surround view system SVS of the vehicle F impossible. Furthermore, with certain objects there is a possibility that the view of the object concerned from just one side does not provide a realistic impression of the respective object. There is also a danger of the vehicle images of the vehicle objects located in the environment of the vehicle F or other objects being heavily influenced by environmental conditions, in particular weather conditions, for example snow.

It is therefore an object of the invention to provide a method and a device for displaying objects on a vehicle display, in which the objects are displayed as realistically as possible, so that in their driving decisions and orientation in the traffic flow the driver is provided with the most efficient possible assistance.

This object is achieved according to the invention by a method with the features indicated in claim 1.

According to this the invention provides a method for displaying objects on a vehicle display comprising the following steps:

providing sensed environment images, that have objects, that are located in the environment of the vehicle,
classifying the objects on the basis of object features in order to detect an object type of the particular object,
inserting a three-dimensional data model corresponding to the detected object type of the object in order to generate a 3-D scene that shows the environment of the vehicle, and
displaying the generated 3-D scene on the vehicle display.

The method according to the invention offers the particular advantage of increased safety when performing vehicle maneuvers, based on the realistic and clear display of the objects located in the environment of the vehicle.

In a possible embodiment of the method according to the invention the three-dimensional vehicle data model of the detected object type is read out from a data memory of the vehicle.

This embodiment offers the advantage of particularly fast access to various 3-D data models.

In an alternative embodiment of the method according to the invention the 3-D data model of the detected object type is downloaded via a wireless downlink connection of a telecommunication system from a remote database.

This embodiment offers the advantage that the database has a particularly large number of different 3-D data models.

Furthermore, it is possible to combine both embodiments, i.e. if a 3-D data model of the detected object type is not contained in the data memory of the vehicle, then the 3-D data model is downloaded via a wireless interface from the remote database.

In a possible embodiment of the method according to the invention the environment images are supplied by a vehicle sensor, in particular by a vehicle camera of the vehicle.

In a further possible embodiment of the method according to the invention the objects have vehicle objects located in the environment of the vehicle and which respectively transmit a corresponding 3-D vehicle data model of the vehicle object and/or an identification of the 3-D vehicle data model to the vehicle directly via a wireless interface or via a telecommunication system.

In a further possible embodiment of the method according to the invention the 3-D vehicle data models and/or identifiers of the 3-D vehicle data models provided by other vehicle objects are received by a receiver of the vehicle directly or via a wireless downlink connection of a telecommunication system.

In a further possible embodiment of the method according to the invention a 3-D vehicle data model and/or an identification of the 3-D vehicle data model of the vehicle is transmitted by a transmitter of the vehicle directly or via a wireless uplink connection of a telecommunication system to other vehicle objects located in the vicinity of the vehicle.

In a further possible embodiment of the method according to the invention a 3-D vehicle data model and/or an identification of the 3-D vehicle data model of a vehicle object located in the vicinity of the vehicle received by a receiver of the vehicle directly or via a wireless downlink connection of the telecommunication system is forwarded by a transmitter of the vehicle directly or via a wireless uplink connection of the telecommunication system to other vehicle objects in the environment of the vehicle.

In a further possible embodiment of the method according to the invention the 3-D vehicle data models and/or identifiers of 3-D vehicle data models of the vehicle itself or of other vehicle objects are transmitted with an instantaneous position of the vehicle or the respective vehicle objects.

The invention also provides a surround view system for a vehicle with the features indicated in claim 9.

According to this the invention provides a surround view system for a vehicle comprising

at least one vehicle sensor unit, in particular a vehicle camera, which provides environment images, showing objects, located in the environment of the vehicle and
a processing unit, which classifies the objects contained in the vehicle image in order to detect a type of the objects and inserts 3-D data objects of the classified objects in the environment image to generate a 3-D scene, which is displayed on a vehicle display associated with the processing unit.

In a possible embodiment of the surround view system according to the invention the further objects in the environment of the vehicle comprise other vehicle objects, which transmit their respective 3-D vehicle data models and/or identifiers of 3-D vehicle data models to a receiver of the surround view system of the vehicle, wherein the received 3-D vehicle data model or the 3-D vehicle data model read out on the basis of the 3-D data model identifier received is displayed on a vehicle display of the vehicle.

In a possible embodiment of the surround view system according to the invention the 3-D vehicle data models and/or identifiers of the 3-D vehicle data models, transmitted by the other vehicle objects, are received by a receiver of the vehicle directly or via a wireless downlink connection of a telecommunication system.

In a further possible embodiment of the surround view system according to the invention this has a transmitter, which transmits its own particular 3-D vehicle data model and/or an identifier of its own particular 3-D vehicle data model to other vehicle objects, located in the environment of the vehicle, directly or via a wireless uplink connection of a telecommunication system.

In a further possible embodiment of the surround view system according to the invention a current position of the particular vehicle itself is transmitted by a transmitter of the surround view system to other vehicle objects, located in the environment of the vehicle, directly or via a wireless uplink connection of the telecommunication system.

In a further possible embodiment of the surround view system according to the invention 3-D vehicle data models and/or identifiers of 3-D vehicle data models of classified objects, in particular vehicle objects, located in the environment of the vehicle, are transmitted to other vehicle objects directly or via a wireless uplink connection of a telecommunication system.

The invention also provides a vehicle containing a surround view system according to the invention, connected with a navigation system of the vehicle, which provides positional data of the vehicle itself and/or of other objects, in particular vehicle objects, for the surround view system.

In the following, possible embodiments of the method according to the invention and the device according to the invention for displaying objects on a vehicle display of the vehicle are explained in more detail with reference to the attached figures.

These show as follows:

FIG. 1 a schematic representation of an exemplary traffic situation to explain an underlying problem for the method according to the invention and the device according to the invention;

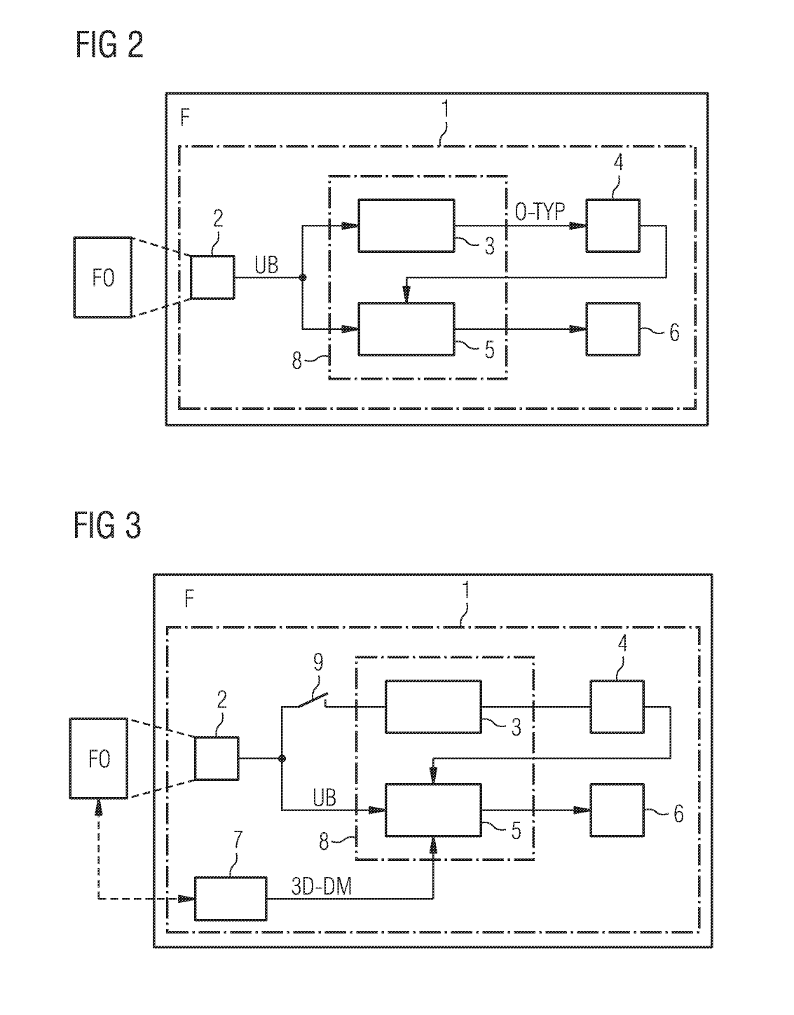

FIG. 2 a block diagram of a possible embodiment of the surround view system according to the invention;

FIG. 3 a block diagram of a further embodiment of the surround view system according to the invention;

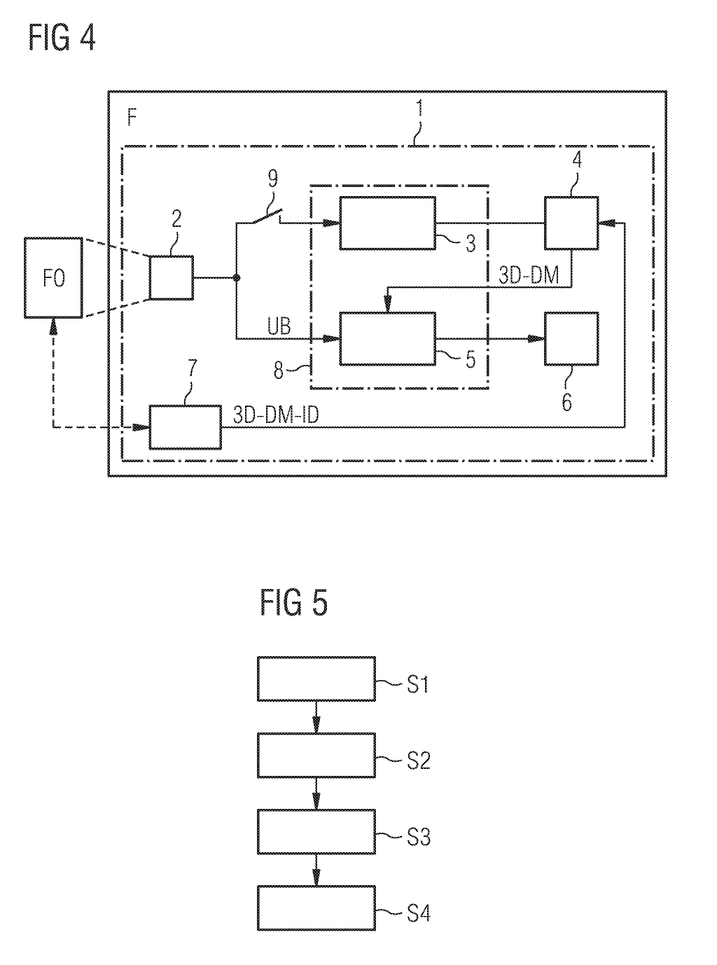

FIG. 4 a block diagram of a further embodiment of the surround view system according to the invention;

FIG. 5 a flow diagram of a possible embodiment of the method according to the invention;

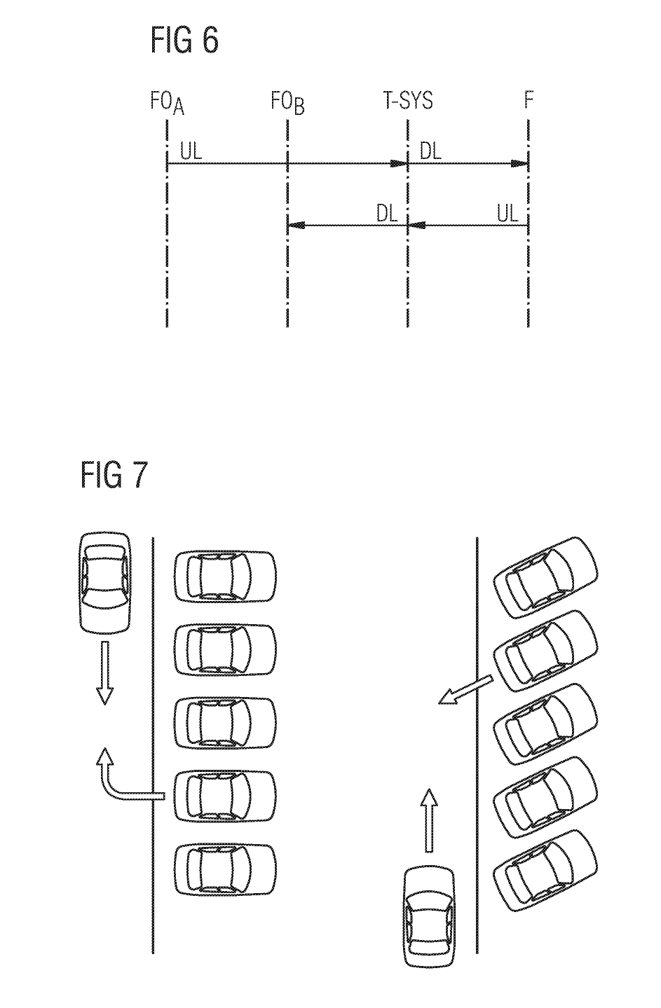

FIG. 6 a signal diagram illustrating a possible embodiment of the method according to the invention;

FIG. 7 a further application for the method according to the invention

As can be seen in FIG. 2, in the exemplary embodiment shown a vehicle F incorporates a surround view system 1, having one or more vehicle sensor units 2, in particular vehicle cameras. The vehicle sensor units 2 can for example have vehicle cameras, supplying images of the vehicle environment in a visible frequency range. Furthermore, the vehicle sensor unit 2 can have a radar sensor, supplying radar data or radar images of the environment of the vehicle F. In the example shown in FIG. 2 the vehicle sensor unit 2 detects an object O located in the environment of the vehicle F, for example a vehicle object FO. The object O is a movable object, for example a vehicle object FO, or an immovable object, for example a building or similar. As can be seen in FIG. 2, the vehicle sensor unit 2, in particular the vehicle camera, detects the object O from one side. Each vehicle sensor unit 2 supplies an environment image of the environment of the vehicle F, wherein the environment image can contain one or more objects O, located in the environment of the vehicle F. During movement of the vehicle F, for example along a highway, the objects O move relative to the vehicle F. The vehicle sensor unit 2 delivers the current environment image, which for example contains the object O, to a classification unit 3 of the surround view system 1.

The classification unit 3 classifies the object O on the basis of object features in order to detect an object type. For example, the classification unit 3 detects that object O is a vehicle object FO. The classification unit 3 can perform a classification with an increasing degree of classification accuracy. For example, on the basis of the object features the classification unit 3 is able to determine that the object O is a vehicle object FO, namely a truck vehicle object LKW-FO or an automobile vehicle object PKW-FO. On the basis of a hierarchy of the objects the classification unit 3 can perform the classification with an increasing degree of accuracy. For example, the classification unit 3 can detect the automobile vehicle object detected as a vehicle of a particular type, for example as a limousine or a station wagon. Furthermore, a further classification can for example be performed of which specific vehicle type is involved, for example an Audi A6 station wagon. In the exemplary embodiment described, the classification unit 3 detects an object type O-TYP of the particular object O, wherein with the help of the detected object type a corresponding three-dimensional data model 3D-DM of the detected object type O-TYP is read out from a data memory 4 and inserted by an insertion processing unit 5 in the environment image UB at the point of the detected vehicle object FO. The three-dimensional vehicle data model 3D-DM of the detected vehicle object FO read out from the data memory 4 is thus inserted at the point or position within the environment image UB, at which the vehicle object FO is located within the environment image UB. Through the insertion of the three-dimensional data model 3D-DM of the detected vehicle object FO the insertion unit 5 generates a 3-D scene, which represents the environment of the vehicle F including the detected vehicle objects FO. The generated 3-D scene is displayed by a vehicle display 6 of the surround view system 1 to a person inside the vehicle F, in particular the driver. An advantage of the exemplary embodiment shown in FIG. 2 is that on the vehicle display 6 of the vehicle F it is not just a visible side of the object O that is shown, but a corresponding three-dimensional vehicle data model 3D-DM of the object O, so that a realistic representation of the object O in the three-dimensional scene occurs. The classification unit 3 and the insertion processing unit 5 are preferably integrated into a processing unit 8. Here the processing, in particular the classifications, preferably takes place in real time.

FIG. 3 shows a further exemplary embodiment of the surround view system according to the invention 1. In the exemplary embodiment shown in FIG. 3, the surround view system 1 incorporates a transceiver 7 that receives from an object O, in particular a vehicle object FO, located in the vicinity of the vehicle F, a vehicle data model 3D-DM corresponding to the vehicle object FO directly or via a wireless downlink connection DL of a telecommunication system. The Transceiver 7 comprises a receiver and a transmitter. The receiver of the transceiver 7 receives from the vehicle object FO, which is simultaneously detected by the sensor unit 2 of the surround view system 1, a 3-D data model of the vehicle object FO or at least an identification ID of the corresponding 3-D vehicle data model. Optionally, the classification unit 3 of the surround view system 1 can also perform a classification of the vehicle object FO from the environment image UB received. This design variant allows a check to be made that the 3-D vehicle object data model 3D-DM received corresponds to the result of the classification. Alternatively, the classification unit 3 can also be automatically deactivated with regard to the classification of the vehicle object FO or switched off by a switch 9, if the transceiver 7 receives a vehicle object data model of the vehicle object FO via the wireless interface DL. The insertion processing unit 5 inserts the vehicle object data model received via the wireless interface by the receiver of the transceiver 7 in the environment image UB supplied by the vehicle sensor unit 2 at the appropriate point and in this way generates a three-dimensional scene of the environment of the vehicle F including the object located in the environment, which is shown on the vehicle display 6 of the surround view system 1. In the exemplary embodiment shown in FIG. 3, a classification within the surround view system 1 can be dispensed with if the receiver of the transceiver 7 receives a vehicle object data model of a vehicle object FO located in the environment. In this embodiment the classification unit 3 is thus used only if the object O located in the environment does not supply a corresponding 3-D model. The embodiment shown in FIG. 3 thus offers the advantage of reducing the processing load on the classification unit 3.

FIG. 4 shows a further exemplary embodiment of the surround view system 1 according to the invention, located in a vehicle F. With the exemplary embodiment shown in FIG. 4, the receiver of the transceiver 7 does not receive a vehicle data model from the object O but rather an identifier ID of the vehicle object data model DM. With the help of this vehicle data model identifier DM-ID received, from the local data memory 4 of the surround view system 1, a corresponding three-dimensional vehicle object data model 3D-DM is read out and inserted by the insertion processing unit 5 at the appropriate point in the environment image UB supplied by the vehicle sensor unit 2, in order to generate a 3-D scene of the environment. The generated 3-D scene is displayed by the vehicle display 6. The embodiment shown in FIG. 4 offers the advantage with regard to the wireless interface that only one vehicle object data model ID has to be transmitted, so that the bandwidth required is low. Depending on the data complexity and quantity, the transmission of the ID of the vehicle object data model can take place substantially more quickly than the transmission of a complete vehicle object data model.

In the embodiments shown in FIGS. 3 and 4 the transmission of the vehicle object data model and/or the vehicle object data model ID can take place directly via a wireless interface from vehicle to vehicle or via a telecommunication system T-SYS. In a possible embodiment the vehicle object FO transmits via an uplink connection UL a model ID or its vehicle data model, which is then transmitted via a downlink connection DL to the receiver of the transceiver 7 within the vehicle F. The telecommunication system is for example a mobile telecommunications system. In a further possible embodiment of the system according to the invention, as shown in FIGS. 2, 3 and 4, apart from the vehicle object data models and/or vehicle object data model IDs, positional data are also exchanged or transmitted between the vehicles or vehicle objects FO. In a possible embodiment, when inserting the vehicle object data model 3D-DM in the environment image UB, the insertion processing unit 5 also takes into consideration the current positional data of the vehicle objects. In a possible embodiment the positional data of the vehicles or of the vehicle objects FO are supplied by navigation systems contained in the vehicle objects. In a possible embodiment the insertion processing unit 5 shown in FIGS. 2, 3 and 4 has a CPU or a microprocessor that receives positional data from a navigation system located in the vehicle F. These positional data comprise the positional data of the particular vehicle itself F and/or the positional data of vehicle objects located in the near vicinity of the vehicle F within the range of the sensor units 2. These positional data comprise two- or three-dimensional coordinates of objects O, in particular vehicle objects FO, in the vicinity of the vehicle F.

In a further possible embodiment of the system according to the invention vehicle objects FO disseminate their particular 3-D vehicle data models and/or 3-D vehicle data model identifiers to other vehicle objects, which for their part forward them to third vehicle objects. The forwarding of the 3-D data models 3D-DM or their identifiers ID can take place either directly between the vehicles or via uplink and downlink connections of a telecommunication system T-SYS. By forwarding 3-D vehicle data models or their identifiers it is possible for a vehicle F to also detect vehicle objects FO that are completely or partially obscured by other vehicle objects, as for example shown in FIG. 1. In the example shown in FIG. 1, the vehicle data object FO2 can, for example, transmit its vehicle data model to the overtaking vehicle object FO1, which then transmits the vehicle data model received or its corresponding identifier to the vehicle F. In a preferred embodiment the vehicle data models and/or their vehicle data model identifiers are transmitted together with the corresponding current positional data of the corresponding vehicle object, so that the surround view system SVS of the vehicle F can determine, at which precise point within the environment the for example obscured vehicle data object FO2 is located. On the basis of the positional data the insertion processing unit 5 of the surround view system according to the invention 1 can then precisely insert the directly- or indirectly-received vehicle object data model 3D-DM at the appropriate point in the detected environment image.

FIG. 5 shows a flow diagram of an exemplary embodiment of the method according to the invention for displaying objects O on a vehicle display.

In a step S1 initially one or more environment images UB are provided, having objects O, that are located in the environment of the vehicle F. These environment images UB are preferably sensed, in particular by means of one or more vehicle cameras and/or by means of a radar device located in the vehicle F. The images received by the various sensors or sensor units, in particular camera images, can be pre-processed and compiled into an environment image. An environment image can show the entire environment of the vehicle F or relevant parts of the environment around the vehicle. The environment image UB can for example show a 360° panoramic image of the environment of the vehicle F. The environment image UB contains the most varied of objects O, in particular movable vehicle objects FO, and immovable objects O, for example build-ings or mountains.

In a further step S2 a classification of the objects O takes place on the basis of object features in order to detect an object type O-TYP of the respective object O. A classification can for example be performed by the classification unit 3 of a surround view system 1 shown in FIGS. 2 to 4.

In a further step S3 a 3-D data model corresponding to the detected object type O-TYP of the object O is inserted to generate a 3-D scene showing the environment of the vehicle F. In a possible embodiment the 3-D data model 3D-DM of the object O is inserted at an appropriate point in the environment image UB, or positioned there, by evaluation of received positional data. In a possible embodiment these positional data or positional coordinates are provided by a navigation system of the vehicle F.

In a further step S4 the generated 3-D scene is displayed on a vehicle display of the vehicle F.

FIG. 6 is a schematic representation of a design variant of a system, in which the method according to the invention can be used. In the design variant shown in FIG. 6 a vehicle F communicates with other vehicle objects FOA, FOB via a telecommunication system T-SYS, for example a mobile telecommunica-tions system. For example, a vehicle object FOA located in the vicinity of the vehicle F can transmit via an uplink connection UL its own particular 3-D vehicle data model or a corresponding ID inclusive of positional data to a base station of the telecommunication system, which then via a downlink connection DL transmits the 3-D data model of the vehicle FOA or a corresponding ID preferably with the corresponding positional data to a receiver of the vehicle F. There the vehicle data model of the vehicle object FOA is inserted at the appropriate point in an environment image UB. Furthermore, the own particular transmitter of the vehicle F transmits a vehicle data model or a corresponding ID of the vehicle F via an uplink data connection UL of the telecommunication system and from there via a downlink connection DL to another vehicle object FOB. Apart from the vehicle data model of the particular vehicle F itself here the received vehicle data model of the vehicle object FOA or a corresponding ID is preferably also forwarded to the vehicle object FOB. Furthermore, the vehicle F can send back the ID of its own particular vehicle data model following receipt of a vehicle data model from the vehicle object FOA by way of confirmation of receipt. In this way the various vehicle objects FO exchange their 3-D vehicle data models or corresponding IDs between them. Here the positional data of the vehicle objects FO are preferably simultaneously exchanged between them.

In an alternative embodiment all vehicles or vehicle objects FO have a corresponding vehicle ID, which uniquely identifies the vehicle. These vehicle IDs are exchanged between the vehicles FO, wherein then through a database query a vehicle data model ID corresponding to the vehicle ID received can be queried.

In a possible embodiment of the method according to the invention the vehicle sensor unit 2 of the surround view system 1 detects an outline of the object O located in the environment together with a texture or color. In a possible embodiment the texture is also used for the classification. Furthermore, it is possible for the insertion unit 5 to insert the detected texture or color of an object in the vicinity of the vehicle F, for example a vehicle object, in the 3-D vehicle data model displayed, so that the corresponding object O is shown more realistically on the vehicle display 6.

Further embodiments of the method and system according to the invention are possible. Thus the objects O can be vehicle objects FO, which move on land, in particular vehicles or trucks. Furthermore, the vehicle objects FO can also be watercraft or aircraft. In a possible embodiment the vehicle data models transmitted are relatively simple vehicle data models, which essentially represent a surface of the corresponding object O. For example, the color and contour of a particular vehicle type is inserted in the environment image UB to generate the 3-D scene. Alternatively, the vehicle data model transmitted can also be a complex vehicle data model of the detected vehicle object FO, which apart from the surface of the vehicle F also offers data on the internal structure of the vehicle object FO concerned. In this design variant the driver or captain of the vehicle F, for example, has the possibility, on the basis of the vehicle data model transmitted, to look inside the inner structure of the vehicle object FO located in the environment and possibly also to zoom in. In this design variant, therefore, if necessary the driver of the vehicle F can receive more information on the design and structure of the vehicle object FO shown on the vehicle display 6 within the 3-D scene.

In a possible embodiment the object O located in the environment moves at a relative speed to the particular vehicle F itself. In a possible embodiment, the relative speed V is detected by the surround view system 1 and taken into consideration in the positioning of the corresponding 3-D vehicle data model in the environment image UB. In this design variant a positioning or insertion of a 3-D vehicle data model can take place more precisely, since apart from positional data relative speeds are also taken into consideration in the calculation of the placement position of the 3-D vehicle data model in the 3-D scene by the insertion unit 5.

The classification unit 3 of the surround view system 1 can, for example, detect and classify the type and the color of another vehicle object FO in the environment of the particular vehicle itself. A corresponding vehicle data model is then inserted or positioned as a 3-D data object in the 3-D scene.

The vehicle data model 3D-DM inserted in the 3-D scene shows a vehicle object FO in the vicinity of the vehicle F from all sides, even from sides which cannot be detected by the vehicle sensor units 2 of the vehicle F. Furthermore, vehicle data models of vehicle objects can also be shown, which are permanently or temporarily obscured by other objects, in particular other vehicle objects. In this way the three-dimensional vehicle environment shown in the 3-D scene is shown more realistically to the driver of the vehicle F, thereby improving their driving decisions and journey familiarization. On the basis of the improved driving decisions the safety when driving the vehicle F is also significantly increased.

FIG. 7 shows a further application for the method according to the invention. Here objects, in particular other vehicle objects, are shown in a 3-D scene on a display of a vehicle I in the process of parking.

1. A method for displaying objects on a vehicle display of a vehicle comprising:
(a) providing sensed environment images that include at least one object located in the environment of the vehicle;
(b) classifying the at least one object on the basis of object features in order to detect an object type of the at least one object;
(c) inserting a three-dimensional data model corresponding to the detected object type of the at least one object in order to generate a three-dimensional scene that shows the environment of the vehicle; and
(d) displaying the generated three-dimensional scene on the vehicle display.

2. The method according to claim 1, wherein the three-dimensional data model of the detected object type is read out from a data memory of the vehicle or downloaded via a wireless downlink connection from a remote database.

3. The method according to claim 1, wherein the environment images are supplied by at least one vehicle sensor, in particular a vehicle camera of the vehicle.

4. The method according to claim 1, wherein the objects have vehicle objects that are located in the environment of the vehicle and in each case transmit a corresponding three-dimensional vehicle data model of the vehicle object and/or an identification of the three-dimensional vehicle data model to the vehicle via a wireless interface.

5. The method according to claim 4, wherein the three-dimensional vehicle data models and/or identifiers of the three-dimensional vehicle data models provided by the other vehicle objects are received by a receiver of the vehicle via a wireless downlink connection of a telecommunication system.

6. The method according to claim 4, wherein the three-dimensional vehicle data model and/or the identification of the three-dimensional vehicle data model of the vehicle is sent by a transmitter of the vehicle via a wireless uplink connection of a telecommunication system to other vehicle objects, that are located in the environment of the vehicle.

7. The method according to claim 4, wherein the three-dimensional vehicle data model and/or the identification of the three-dimensional vehicle data model of another vehicle object located in the vicinity of the vehicle received by a receiver of the vehicle via a wireless downlink connection of the telecommunication system is forwarded by a transmitter of the vehicle via a wireless uplink connection of the telecommunication system to other vehicle objects in the environment of the vehicle.

8. The method according to claim 4, wherein the three-dimensional vehicle data models and/or identifications of three-dimensional vehicle data models of the vehicle or of another vehicle object are transmitted together with an instantaneous position of the respective vehicle or vehicle object.

9. A surround view system for a vehicle, the system comprising:
at least one vehicle sensor unit providing environment images showing objects that are located in the environment of the vehicle; and
a processing unit is configured to classify the objects contained in the environment images in order to detect object types of the objects and inserts three-dimensional data models of the classified objects in the environment images to generate a three-dimensional scene, which is displayed on a vehicle display associated with the processing unit.

10. The surround view system according to claim 9, wherein other objects, in particular vehicle objects, that are located in the environment of the vehicle, transmit their own particular 3-D vehicle models and/or 3-D data model identifiers via a wireless data link to the vehicle.

11. The surround view system according to claim 10, wherein the three-dimensional data models and/or identifiers of three-dimensional data models, distributed by other vehicle objects, are received by a transmitter of the vehicle via a wireless downlink connection of a telecommunication system.

12. The surround view system according to claim 9, wherein the vehicle transmits its own particular three-dimensional vehicle model and/or an identifier of the own particular three-dimensional vehicle model to other vehicles, that are located in the environment of the vehicle, via a wireless uplink data connection of a telecommunication system.

13. The surround view system according to claim 9, wherein the vehicle detects its own particular current position and transmits this position to other vehicle objects, that are located in the environment of the vehicle, via a wireless uplink data link of the telecommunication system.

14. The surround view system according to claim 9, wherein the vehicle forwards received three-dimensional vehicle data models and/or identifiers of three-dimensional vehicle data models of classified objects, that are located in the environment of the vehicle, to other vehicle objects, that are located in the environment of the vehicle, via a wireless uplink connection of the telecommunication system.

15. A vehicle comprising:
a navigation system which provides positional data of the vehicle and/or positional data of other vehicle objects that are located in the environment of the vehicle; and
a surround view system comprising
at least one vehicle sensor unit providing environment images, showing objects that are located in the environment of the vehicle, and
a processing unit which classifies the objects contained in the environment images in order to detect object types of the objects and inserts three-dimensional data models of the classified objects in the environment images to generate a three-dimensional scene, which is displayed on a vehicle display associated with the processing unit.
